(19) United States
(12) Patent Application Publication
(10) Pub. No.: US 2022/0289214 A1
(43) Pub. Date: Sep. 15, 2022

(54) INFORMATION EXCHANGE DEVICE PROVIDED WITH CHAT DISPLAY PART

(71) Applicant: JastecM CO., LTD., Gyeonggi-do (KR)

(72) Inventor: Yongbeom BAEK, Gyeonggi-do (KR)

(21) Appl. No.: 17/412,541

(22) Filed: Aug. 26, 2021

(30) Foreign Application Priority Data
Mar. 11, 2021 (KR) 10-2021-0032244

(51) Int. Cl. B60W 50/02; B60W 40/12; G07C 5/08; G07C 5/00; G16Y 20/30

(52) U.S. Cl. CPC B60W 50/0205; B60W 40/12; G07C 5/0808; G07C 5/006; G07C 5/008; G07C 5/004; G16Y 20/30; B60W 2050/021; B60W 2530/209; B60W 2756/10

(57) ABSTRACT

An information exchange device according to an embodiment includes a user terminal to which first data including a user command is input, an IOT terminal for generating second data including information of a thing, and a cloud server provided with a first communication part for exchanging the first data with the user terminal, a second communication part for exchanging the second data with the IOT terminal, a command extraction part for extracting the user command from the first data, an information extraction part for extracting the information of the thing matching the user command from the second data, and an AI controller for calculating the user command and the information of the thing and generating third data that is a response to the first data, wherein the cloud server and the user terminal exchange the first data and the third data in a chat format with each other.

### CROSS REFERENCE TO RELATED APPLICATION

The present application claims priority to Korean Patent Application No. 10-2021-0032244, filed Mar. 11, 2021, the entire contents of which is incorporated herein for all purposes by this reference.

### BACKGROUND

### 1. Field

The present invention relates to an information exchange device provided with a chat display part through which a user may exchange information of a thing.

### 2. Description of the Related Art

IOT (Internet of Things) technology is a technology that collects, stores, and analyzes data by using sensors and communication functions in various devices, and may refer to a technology for connecting to the Internet by means of embedding sensors and communication functions in various things, that is, a technology for connecting various things through wireless communication.

When IOT technology is used, a user may easily control and manage surrounding information or state information of each thing, so IOT may be used in various fields.

### SUMMARY

The present invention may be an information exchange device provided with a chat display part in a conversation format for a user to easily manage or control a thing by using information that is exchanged with the thing.

The present invention is an information exchange device, including: a user terminal to which first data including a user command is input; an IOT terminal for generating second data including information of a thing; and a cloud server provided with a first communication part for exchanging the first data with the user terminal, a second communication part for exchanging the second data with the IOT terminal, a command extraction part for extracting the user command from the first data, an information extraction part for extracting the information of the thing matching the user command from the second data, and an AI controller for calculating the user command and the information of the thing and generating third data that is a response to the first data, wherein the cloud server and the user terminal exchange the first data and the third data in a chat format with each other.

A chat display part for outputting the first data and the third data, which are exchanged between the cloud server and the user terminal, may be provided, the chat display part may be output on a display screen of the user terminal, and the first data and the third data of the chat display part may be displayed in a conversational format according to a time sequence.

The thing on which the IoT terminal of the present invention is provided may not be limited to a specific thing such as a vehicle, but may be applied to all things to which IoT technology is applicable through sensors and the like.

A typical IoT terminal may include a simple CPU or other computing devices, so it may not perform complex computing functions such as those of artificial intelligence (AI). That is, most IoT terminals may be only able to execute a simple command such as on/off, but the present invention may include a high-performance CPU in the cloud server, and an AI controller capable of recognizing or analyzing voice or text data.

The IOT terminal may include IOT terminals in which a first IOT terminal and a second IOT terminal are respectively provided in a first thing and a second thing, and the first IOT terminal and the second IOT terminal may be operated by interworking with each other to exchange information with the user.

As an exemplary embodiment, an IoT motion detection sensor for preventing theft at an entrance to a living room of a home and a home IoT lamp may be provided. A user or owner may input first data as “detect a thief” into a chat display part through a user terminal, and an AI controller may calculate corresponding third data. That is, the IoT motion detection sensor for preventing theft at the entrance to the living room may be turned on, a home IoT lamp may also be interworked with the IoT motion detection sensor to perform the turn-on operation, and a few minutes after the user lies in bed, the home lamp may be turned off.

The AI controller may generate action pattern information of the user, the second data corresponding to the action pattern information may be transmitted from the IOT terminal to the cloud server, and the AI controller may analyze a user's action pattern obtained from the second data and calculates the third data in response to user's action repeated in a specific time period.

Accordingly, by the third data, the IOT terminal may be operated in response to the third data even when there is no user command.

According to the present invention, the user may perform an operation process in the conversational format by a familiar means such as a chat or voice with a thing through the chat display part.

That is, the first data corresponding to the user's command and the third data of the AI controller corresponding to the first data may be output to the chat display part, so that the user may experience a feeling of having a conversation with the thing or IoT terminal, just like a conversation between people.

By using a user terminal such as a smartphone, a user may receive state information of a thing provided through an IOT terminal, and similarly, the user may input a command and the like through his or her user terminal, thereby identifying the state information of the thing.

The present invention may include: a chat display part for displaying an input such as a command input by a user and data or signals transmitted by an IOT terminal of a thing in a mutual messenger method, wherein the user may input the command or question by voice or chat through the chat display part, the chat display may display the user's input data and output data transmitted from an AI controller to the user, and in this way, the user may experience a feeling of having a conversation with the thing, just like a conversation between people.

The AI controller may compare or match first data, transmitted from a user terminal to a cloud server, and second data, transmitted from an IOT terminal to the cloud server in response to the first data, with each other, and may output third data obtained by translating state information of a thing, corresponding to the second data, into a daily conversation message that enables a person to feel like having a conversation.

In addition, in a case where the chat display part recognizes, inputs, and outputs user's voice, it is convenient for a user because the user may simply recognize the state or information of a thing without directly pressing a user terminal or looking at a screen of the user terminal.

### BRIEF DESCRIPTION OF THE DRAWINGS

FIG. 1 is a view showing an exemplary embodiment in which a chat display part of the present invention is applied to a vehicle.

FIG. 2 is a schematic block diagram of the present invention.

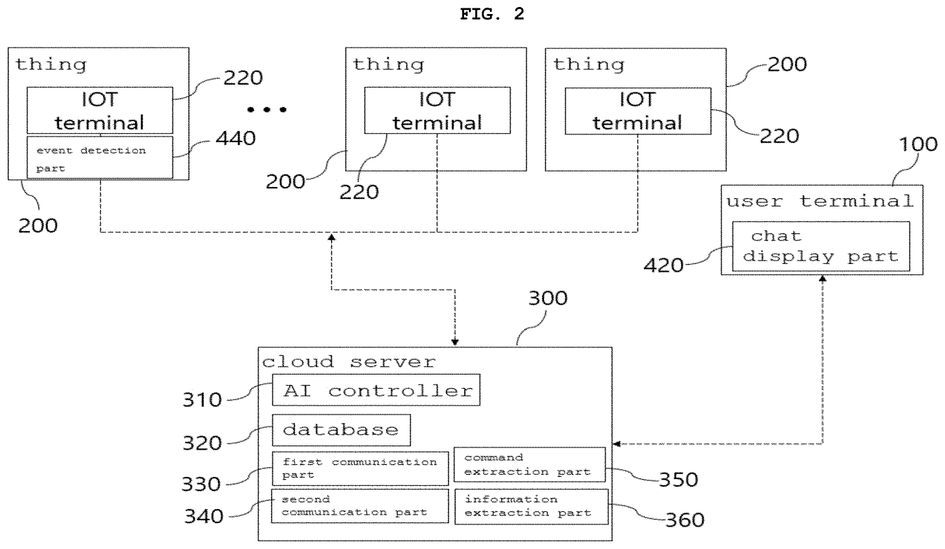

FIG. 3 is an explanatory view showing a data flow over time according to an exemplary embodiment of the present invention.

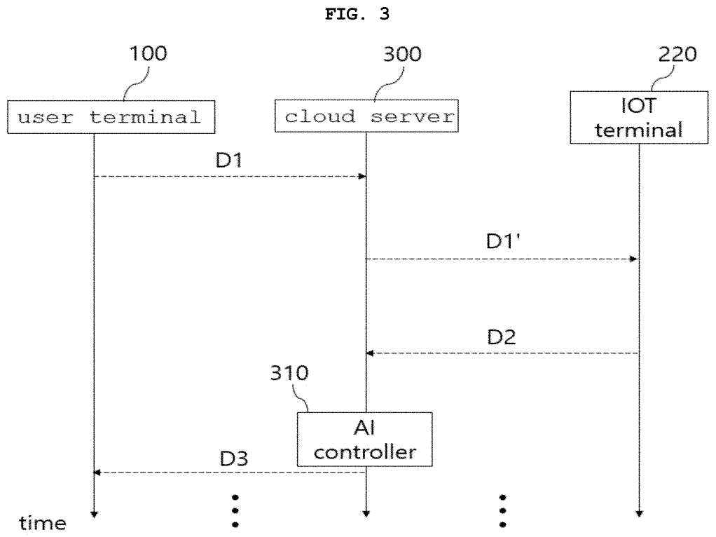

FIG. 4 is a view showing another exemplary embodiment of FIG. 3.

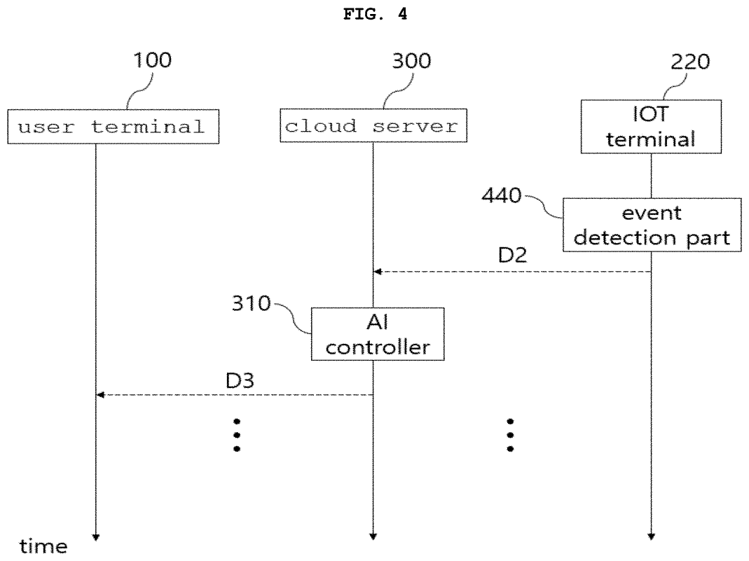

FIG. 5 is an explanatory view showing a relationship between data according to the present invention.

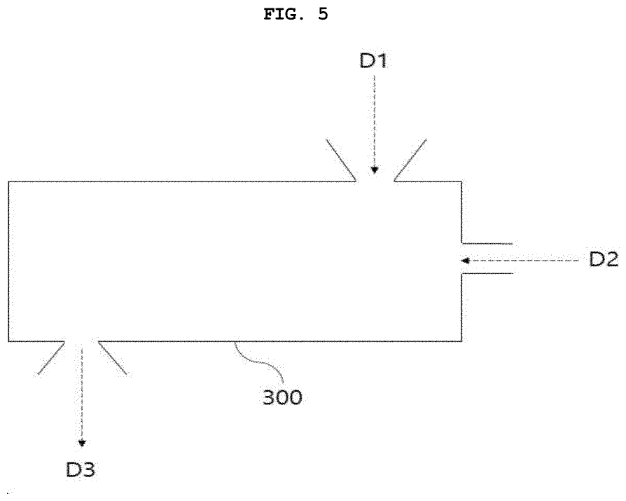

FIG. 6 is a view showing another exemplary embodiment of FIG. 1.

### DETAILED DESCRIPTION

In the present invention, it is possible to actively exchange information between a user and an IOT terminal 220 provided in a thing 200 through a chat display part 420 of a user terminal 100, and when the user uses the thing 200, the IOT terminal 220 does not merely output a simple passive answer or response to an input of a user's command or question, but the IOT terminal 220 provides or presents state information of the thing to the user, so that the user may experience a feeling of having a conversation with the thing 200, similar to a conversation between people.

In an active information exchange, when a user inputs information of a question or command to a thing through the user terminal 100, not only the thing simply understands the input information accurately and outputs the corresponding information, but also data such as a warning alarm is actively transmitted and displayed through the chat display part 420 when a preset event occurs, so that the user may intuitively and easily identify a change in the state of the thing 200.

In an event, in addition to detecting state information of the thing 200 or information around the thing 200, the AI controller 310 may analyze a user's action pattern. Even when there is no input such as a user's command, by reacting to repetitive user actions at the same time period every day, the IoT terminal 220 may perform an action corresponding to the third data such as turning on or off, or may ask the user whether to execute an action before its execution.

Anything capable of exchanging its own information or information around itself with a user through an IOT terminal using IOT technology may be referred to as a thing 200.

The IOT terminal 220 may include IOT terminals 220 in which a first IOT terminal may be provided in a first thing, and a second IOT terminal may be provided in a second thing. The plurality of IOT terminals may interwork with each other to exchange information with a user. For example, a motion detection sensor may be turned on according to a thief-detection command, and a lamp in a bedroom may be turned off after a predetermined time.

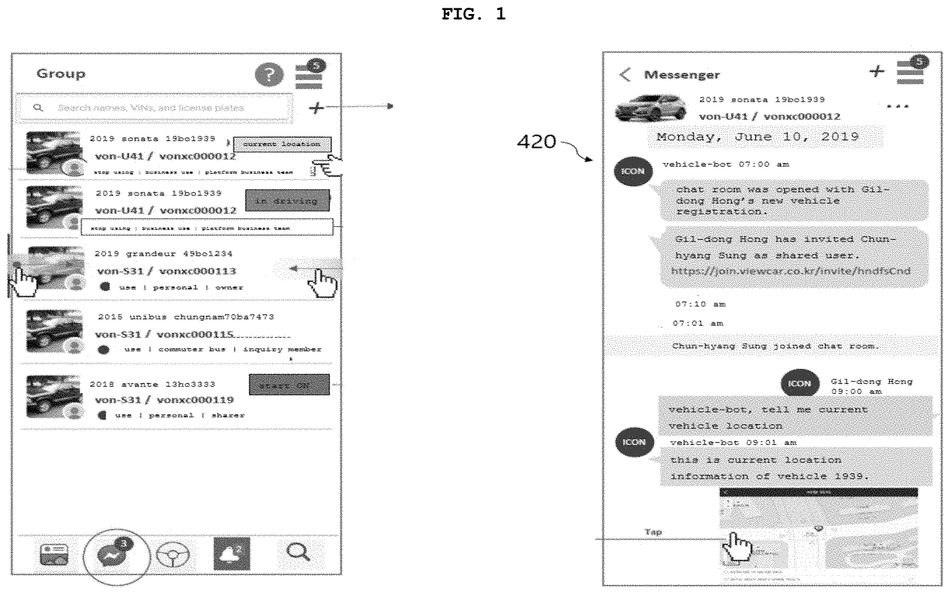

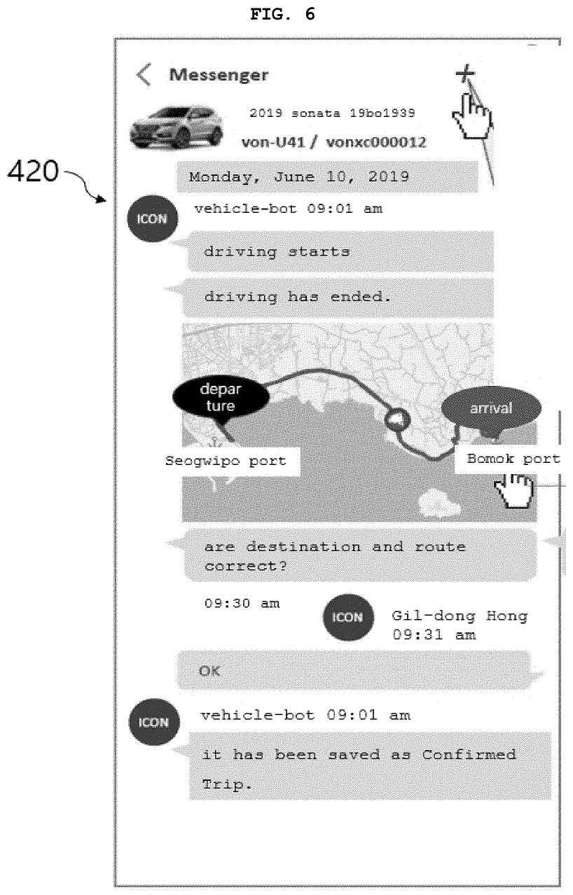

FIGS. 1 and 6 may illustrate an exemplary embodiment in which a chat display part is applied to a vehicle, wherein the chat display part provides or displays the first data equivalent to input data and the third data equivalent to output data in a time sequence, which are generated between a user and a thing 200.

A thing 200 may be equipped with an IOT terminal 220, and when applied to a vehicle, the IOT terminal 220 may be referred to OBD (On-Board Diagnostics). OBD is a diagnostic standard for checking and controlling an electrical or electronic operating state of a vehicle, and may increase maintenance efficiency of electronic parts such as an engine. OBD also serves as a computer interface that informs a vehicle driver and user of various vehicle information, so as to enable a maintenance engineer and vehicle driver to recognize and diagnose problems by means of recording fault codes, turning on a warning lamp in a cluster in the vehicle, etc.

A user or owner of a thing 200 may receive state information of the thing 200 provided by an IOT terminal 220 by using a user terminal 100 such as his or her own smartphone, and in a similar manner, the user may recognize the state information of the thing 200 by inputting a command and the like through the user terminal 100.

In order to check and control an operating state of the thing 200 through an application, the user may recognize the state information of the thing 200 through various menus indicating a current state of the thing 200.

As an exemplary embodiment, when the thing 200 is a vehicle, various vehicle information may be displayed on the application of a smart phone.

Various vehicle information may include: a warning display showing a malfunction of transmission control (i.e., gearbox), a body electronic equipment (i.e., electrical or electronic equipment of a vehicle), a battery, an engine, an airbag, a suspension, a fuel tank, a communication function, or the like.

In addition, the vehicle information may include a driving analysis display that synthesizes information of fuel economy, a safety score, or an eco-score during a predetermined time interval such as a day or week interval.

In addition, the vehicle information may include statistics of a vehicle account book that shows a total expenditure for a vehicle, including gas fuel, maintenance cost, product purchase, and other expenses of the vehicle.

In addition, the vehicle information may include a warning display or an alarm indicating a free parking time of a parking lot.

The state information indicating such vehicle information may indicate a part of the exemplary embodiment of a wide variety of menus. That is, the vehicle state information may refer to any information that is able to be collected and provided through a vehicle, the information including: a location of the vehicle; which user is using when multiple users are registered in a single vehicle; driving history in which a driving route including a departure and a destination is displayed on a map; and the like.

In order to identify various state information of the vehicle through an application, a user should navigate various information menus having a tree structure or a radial structure, and select a menu or enter the menu, whereby it is inconvenient for the user to use the application, and also it may be dangerous to safety due to the fact that the user is likely to overlook a fault signal that must be checked at an appropriate time.

Accordingly, the present invention may include a chat display part 420 that displays input, such as a command input by a user, and data or signals transmitted by an IOT terminal 220 of a thing 200 in a mutual messenger method.

The user may input a command or question by voice or chat through the chat display part 420, and the data input to a user terminal 100 may be transmitted to a cloud server 300.

The cloud server 300 may be provided with a database 320 including various member information, state information of a thing 200, information around the thing 200, and the like.

The present invention may include an AI controller 310, wherein the AI controller 310 may analyze data input to the user terminal 100 and translate the data into a mostly similar human language. When the input data of the user terminal 100 is transmitted, the AI controller 310 may generate an interrupt signal D1′. When the interrupt signal D1′ is transmitted from the cloud server 300 to the IOT terminal 220, the state information of the thing 200 may be transmitted from the IOT terminal 220 to the cloud server 300. Accordingly, the AI controller 310 may generate output data by comparing or matching the input data of the user terminal 100 with the input data received from the IOT terminal 220. The output data is provided to the chat display part 420 so that the user may check the output data.

That is, the chat display part 420 may display the input data of the user and the output data transmitted from the AI controller 310 to the user, and in this way, similar to a conversation between people, the user may experience a feeling like having a conversation with the thing 200.

Referring to the above process as a flow of data, the data may include: first data D1 that is data input from a user terminal 100; an interrupt signal D1′ that is a signal indicating that the first data D1 is input from a cloud server 300 to an IOT terminal 220; second data D2 that is information of a vehicle 200 and sent from the IOT terminal 220 to the cloud server 300 in response to the interrupt signal D1′; and third data D3 that is output data generated by comparing or matching the first data D1 and the second data D2, which are stored in the database 320 of the cloud server 300 by the AI controller 310.

When a user inputs a voice or a text into the chat display part 420, a data flow may occur in order of the first data D1, the interrupt signal D1′, the second data D2, and the third data D3, and the AI controller 310 may calculate the third data D3 equivalent to output by using the first data D1 and second data D2 equivalent to the input. Accordingly, the first data D1 and the third data D3 may be displayed on the chat display part 420.

In a case where the thing 200 is a vehicle, the second data D2 may include not only state information of the vehicle itself, such as states of parts of the vehicle, but also any information, available through the vehicle, such as GPS information of the vehicle, speed information, and surrounding information obtained through a camera installed in the vehicle.

In the present invention, in addition to finding the most appropriate answer in response to a user's stimulation, when an event such as risk detection, malfunction, and replacement of the thing 200 occurs due to various state changes of the thing 200, the event may be displayed by a voice or a text on the chat display part 420. That is, even when there is no human input stimulation, when an event detection part 440 detects an occurrence of a specific event of the thing 200, the second data D2 is transmitted from the IOT terminal 220 to the cloud server 300, and the AI controller 310 may appropriately translate the occurrence of the event, so as to transmit the third data D3 to the user terminal 100.

The occurrence of the event may be detection by a sensor, or may mean satisfaction of a specific condition. That is, even when the first data D1 of the user terminal 100 is not transmitted, the event detection part 440 may notify the occurrence of the event to the user terminal 100.

A case in which the thing 200 is a vehicle will be described as an example.

The event may be a change in the remaining fuel quantity, and the second data D2 can be “The fuel quantity has changed. Would you like to enter the cost of gas in your car balance sheet?”.

The event may be the detection of a fault code, and the second data D2 can be “a fault code has been detected. Would you like to stop by the repair shop?”.

The event be the detection of a part abnormality, and the second data D2 can be “The battery voltage is below the set threshold, so management is required.”.

The event may be the arrival of a maintenance period, and the second data D2 can be “It is time for regular vehicle maintenance. Would you like to go to the repair shop?”.

The event may be the arrival of the time to replace the consumables, and the second data D2 can be “Engine oil change cycle has 7 days left. Do you want to change the engine oil?”.

The third data D3 displayed on the chat display part 420 may be an ordinary conversational message such as, for example, “a failure of the thing 200 has been detected”, “the battery voltage is low”, and “please drive more safely”.

That is, the AI controller 310 may compare or match the first data D1 and the second data D2, and output the third data D3 in which the state information of the vehicle 200 corresponding to the second data D2 is translated into a normal conversation message enabling a person to feel like having a real conversation.

Similar to a general chatbot, the chat display part 420 may record voices or texts in a time sequence, and in this way, a user or owner may easily identify changes in the state of the thing 200 as a whole on a daily or weekly basis.

For example, when the thing 200 is a vehicle, a person receiving information from the chat display part 420 may be a user or driver of the vehicle. In other words, the person receiving information from the chat display part 420 may be not only an owner of the vehicle, but also any person including: a person who leased the vehicle, a company employee, a family member, and the like.

A vehicle management part capable of managing the entire vehicle 200 registered by the user may be provided. The vehicle management part may add, change, or delete information of users for each vehicle. That is, when a plurality of vehicles is registered, the vehicle management part may include a first vehicle and a second vehicle, and a user registered as the first vehicle user may automatically participate in a chat on the first chat display part 420, and a user registered as the second vehicle user may automatically participate in a chat on the second chat display part 420.

In addition, when the chat display part 420 recognizes, inputs, and outputs a user voice, it may be convenient for the user to simply recognize the state or information of the thing 200 without directly pressing the user terminal 100 or looking at the screen of the user terminal 100.

What is claimed is:

1. An information exchange device comprising:
a user terminal to which first data including a user command is input;
an IOT (Internet of Things) terminal for generating second data including information of a thing; and
a cloud server provided with:
a first communication part for exchanging the first data with the user terminal;
a second communication part for exchanging the second data with the IOT terminal;
a command extraction part for extracting the user command from the first data;
an information extraction part for extracting the information of the thing matching the user command from the second data; and
an artificial intelligence (AI) controller for calculating the user command and the information of the thing and generating third data that is a response to the first data,
wherein the cloud server and the user terminal exchange the first data and the third data in a chat format with each other.

2. The information exchange device of claim 1, wherein a chat display part for outputting the first data and the third data, which are exchanged between the cloud server and the user terminal, is provided;
the chat display part is output on a display screen of the user terminal; and
the first data and the third data of the chat display part are displayed in a conversational format according to a time sequence.

3. The information exchange device of claim 1, wherein the IOT terminal comprises IOT terminals in which a first IOT terminal and a second IOT terminal are respectively provided in a first thing and a second thing; and
the first IOT terminal and the second IOT terminal are operated by interworking with each other to exchange information with the user.

4. The information exchange device of claim 1, wherein the AI controller generates action pattern information of the user;
the second data corresponding to the action pattern information is transmitted from the IOT terminal to the cloud server;
the AI controller analyzes a user's action pattern obtained from the second data and calculates the third data in response to user's action repeated in a specific time period; and
by the third data, the IOT terminal is operated in response to the third data even when there is no user command.

5. The information exchange device of claim 1, wherein an interrupt signal indicating an occurrence of the first data is transmitted from the cloud server to the IOT terminal when the first data is transmitted to the cloud server; and
the second data is transmitted from the IOT terminal to the cloud server when the interrupt signal is transmitted to the IOT terminal.

6. The information exchange device of claim 1, wherein the second data is transmitted from the IOT terminal to the cloud server in response to the first data when the first data is transmitted to the cloud server; and
the AI controller matches the first data and second data, extracts the information of the thing, corresponding to information of the first data, from the second data, and calculates the third data.

7. The information exchange device of claim 1, wherein the first data is not transmitted from the user terminal to the cloud server and the event related to the information of the thing is detected by an event detection part;
the occurrence of the event is detection by a sensor, or satisfaction of a specific condition;
the event comprises a change in the remaining fuel quantity, the detection of a fault code, the detection of a part abnormality, the arrival of a maintenance period, or the arrival of the time to replace the consumables when the thing is a vehicle;
the IOT terminal transmits the second data corresponding to an event to the cloud server; and
the AI controller outputs the third data calculated from the second data to a chat display part.

8. The information exchange device of claim 1, wherein the thing is a vehicle, and the IOT terminal is on-board diagnostics (OBD).

9. The information exchange device of claim 1, wherein, when the thing is a vehicle, the second data comprises a part state, GPS information, speed information, a camera image, and the information of the thing around the vehicle, the information of the thing being obtained through at least one of sensing devices.
